(19) United States
(12) Patent Application Publication
(10) Pub. No.: US 2026/0350722 A1
(43) Pub. Date: Nov. 5, 2026

(54) SYSTEM AND METHOD FOR PROVIDING CONSTRUCTION MEDIATION SERVICE FOR MATCHING CLIENT AND TECHNICIAN

(71) Applicant: Geon Woo KIM, Seoul (KR)

(72) Inventor: Geon Woo KIM, Seoul (KR)

(21) Appl. No.: 19/102,931

(22) PCT Filed: Oct. 31, 2022
(86) PCT No.: PCT/KR2022/016807

§ 371 Date: Feb. 11, 2025

(30) Foreign Application Priority Data
Aug. 16, 2022 (KR) 10-2022-0101730

(51) Int. Cl. G06Q 50/08; G06Q 30/0282; G06Q 30/0601

(52) U.S. Cl. CPC G06Q 50/08; G06Q 30/0282; G06Q 30/0619

(57) ABSTRACT

A system for providing a construction mediation service according to the present invention comprises: a client terminal for setting construction site location information and the construction type, and requesting an estimate of the construction; a technician terminal for receiving the construction estimate request, identifying the construction type, and inputting the construction estimate; a mediation server for communicating with the client terminal and with the technician terminal, guiding matching between a client and a technician, and mediating a contract between the matched client and technician; and a communication network for connecting the client terminal, the technician terminal, and the mediation server in a wired or wireless manner. The mediation server comprises: a construction analysis unit for analyzing the construction type and determining whether a deposit agreed on between the client and the technician belongs to a normal transaction range; and a deposit confirmation unit for confirming whether the deposit has been transferred from the client terminal to the mediation server and, if the total amount of the deposit has been transferred, sending a construction start signal to the technician terminal.

### TECHNICAL FIELD

The present invention relates to a system for providing a construction mediation service that can be used for various constructions such as remodeling and interior design, and more particularly to a system for providing a construction mediation service that can receive estimates from various interior design companies when a client requests an estimate for constructions such as interior design, and provide optimal assistance to the client in selecting the desired company.

### BACKGROUND

In recent years, the market size of interior constructions has increased, a new type of business models have been created that provide online interior construction estimate services and interior company connection services using the Internet.

In particular, many people carry out interior construction work to create a new atmosphere when a long time has passed since construction or when they do not like the interior of a newly built house. However, even though they search for interior companies through the Internet or various brochures, it is not easy to find a suitable interior company if they do not have specialized knowledge in the field. Further, many people have difficulty in finding an interior company because they are not sure whether the interior company they found through the Internet or brochures has the ability to do the construction work well. Therefore, people mainly search for interior companies through recommendations from people they know, or rely on advertising phrases.

Korean Unexamined Patent Publication No. 2020-0122947 (Prior Literature 1) discloses a system for interior mediation that allows consumers to easily secure partner companies for each interior construction process, and partners can submit estimates without visiting the site, thereby improving the convenience of using the system. As another example, Korean Unexamined Patent Publication No. 2017-0111182 (Prior Literature 2) discloses a matching system that can mediate companies that carries out the architectural interior construction desired by the client based on the client's location.

However, the construction mediation system according to these prior literatures does not disclose specific details about providing and matching the optimal company information in consideration of the distance from the client, the client's evaluation, and the expertise in the relevant field. In this respect, there was a clear drawback in that it was merely a simple mediation between the client and the construction technician. Further, since the problem related to the defect warranty and construction cost deposit of small-scale companies during interior construction was not properly resolved, there was also a fundamental problem of the mediation system that could not properly resolve the cause of construction delays and various disputes.

### DETAILED DESCRIPTION OF THE INVENTION

### Technical Problem

The present invention relates to a mediation service that can appropriately match a client in need of construction with a specialized engineer for the construction, and the purpose of the invention is to provide a system for providing a construction mediation service that solves the problem of unpaid construction costs by having the client pay a deposit in a mediation server before construction begins, and that introduces a review system for the client after completion of the construction to prevent the problem of poor construction by technicians.

### Technical Solution

A system for providing a construction mediation service according to the present invention comprises: a client terminal for setting construction site location information and the construction type, and requesting an estimate of the construction; a technician terminal for receiving the construction estimate request, identifying the construction type, and inputting the construction estimate; a mediation server for communicating with the client terminal and with the technician terminal, guiding matching between a client and a technician, and mediating a contract between the matched client and technician; and a communication network for connecting the client terminal, the technician terminal, and the mediation server in a wired or wireless manner, wherein the mediation server comprises: a construction analysis unit for analyzing the construction type and determining whether a deposit agreed on between the client and the technician belongs to a normal transaction range; and a deposit confirmation unit for confirming whether the deposit has been transferred from the client terminal to the mediation server and, if the total amount of the deposit has been transferred, sending a construction start signal to the technician terminal.

### Advantageous Effects

According to the proposed invention, when a client requests an estimate for interior or remodeling construction, a push alarm is sent to a technician who matches the nature of the construction, in consideration of the technician's area of activity and the technician's field of expertise, so that there is an advantage in that an optimized matching between the client and the technician can be achieved.

Further, according to the present invention, client's request for an estimate, the technician's presentation of an estimate, and the chat consultation between the client and the technician are all conducted free of charge, except for the success fee at the time of completion of the construction transaction, so that there is an advantage in that the client and the technician can freely communicate about the construction.

Further, according to the present invention, before the start of the construction, the construction will not start unless the client pays a deposit, thereby minimizing the occurrence of disputes such as construction delays due to non-payment of construction costs. After construction is completed, the client can confirm the construction status and leave a review, which also has the advantage of minimizing the problem of poor construction.

Further, according to the present invention, a dispute adjustment unit is provided for resolving disputes between a client and a technician, and free consultations and on-site evaluations are conducted, which has the advantage of greatly improving the satisfaction of service users.

### BRIEF DESCRIPTION OF THE DRAWINGS

FIG. 1 is a diagram showing a three-way communication relationship between a construction client, a specialized technician in the construction field, and a mediation server according to an embodiment of the present invention.

FIG. 2 is a block diagram showing communication between a client, a technician, and a mediation server.

FIG. 3 is a flow chart showing the overall process of a construction contract between a client and a technician.

FIG. 4 is a flow chart explaining in detail the process of sending an estimate request alarm to a technician in response to a construction request from a client, and the process of sending a preliminary estimate by the technician.

FIG. 5 is a flow chart explaining the setting of a deposit and the progress of construction work depending on whether or not the deposit is paid.

FIG. 6 is a diagram showing an example of a smartphone screen related to a request for a construction estimate by a client.

FIG. 7 is a diagram showing an example of a smartphone screen on which a consultation about estimates, etc. is conducted between a client and a technician.

FIG. 8 is a diagram showing an example of a smartphone screen on which a technician sends the discussed estimate to a client.

FIG. 9 is a diagram showing an example of a smartphone screen in which a client checks the status of the construction work after the construction completed and writes a review.

### DETAILED DESCRIPTION OF THE EMBODIMENTS

While the present invention is susceptible to various modifications and alternative embodiments, specific embodiments thereof will be exemplified and explained in detail below. However, it should be understood that there is no intention to limit the present invention to the particular embodiments disclosed, but on the contrary, the present invention is to cover all modifications, equivalents, and alternatives falling within the spirit and scope of the present invention. In describing each drawing, the same or similar components will be denoted with the same reference numerals.

Unless otherwise defined, all terms including technical and scientific terms used herein have the same meaning as commonly understood by a person of ordinary skill in the art to which the present invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, example embodiments of the present invention will be described with reference to the accompanying drawings in detail.

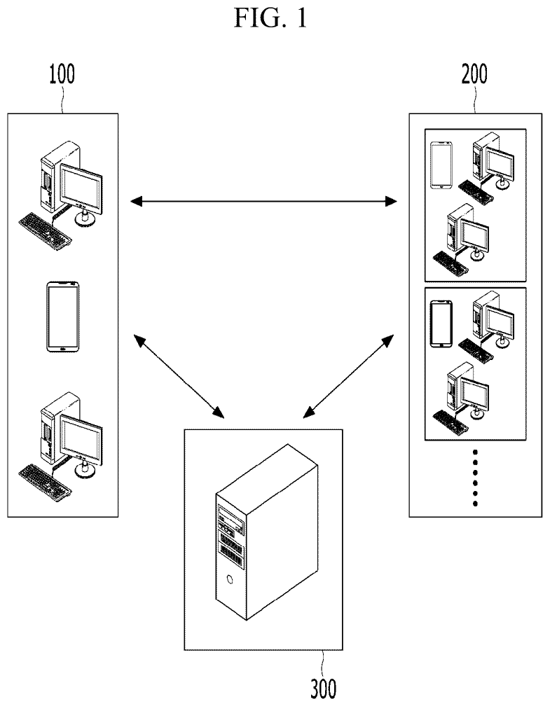

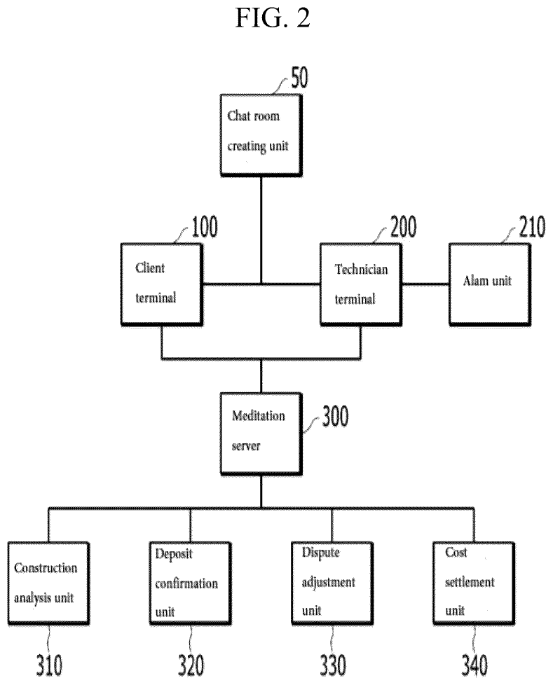

FIG. 1 is a diagram showing a three-way communication relationship between a construction client, a specialized technician in the construction field, and a mediation server according to an embodiment of the present invention, and FIG. 2 is a block diagram showing communication between a client, a technician, and a mediation server.

Referring to FIGS. 1 and 2, the system for providing a construction mediation service according to the present invention has the biggest feature that a client terminal 100, a technician terminal 200, and a mediation server 300 carry out three-way communication with each other. The three-way communication method can be realized through a communication network that is connected by wire or wirelessly. The types of the client terminal 100 and the technician terminal 200 are not limited as long as they are electronic devices capable of communication, such as smart phones, computers, tablet PCs, and the like.

The client terminal 100 is a device used by a client in need of the construction such as interior or remodeling, and can set location information and the type of construction. That is, the client terminal 100 can input information about the construction and perform a function of notifying a technician who can perform the construction work and requesting a construction estimate. At this time, the type and location of the construction site are not limited, and it can be used normally in any region nationwide as long as the location can be identified.

The technician terminal 200 receives the contents of the construction estimate requested by the client terminal 100. That is, the technician terminal 200 can identify information about the construction, such as the type of construction and the location of the construction site, and can receive a signal for a request for an estimate. Specifically, the technician terminal 200 includes an alarm unit 210 that transmits an alarm signal for a request for construction estimate. The alarm signal may be, for example, a push alarm signal. That is, when information about the client's request for an estimate is transmitted, the alarm unit 210 identifies the type of construction transmitted from the client terminal 100 and extracts information about the technician's construction area of activity. If the condition that the type of construction belongs to the technician's specialty and the location of construction site belongs to the technician's possible construction activity area is satisfied, the alarm unit 210 transmits an alarm signal to the technician. Thereby, the technician can know that a construction project that meets the conditions the technician is scheduled to proceed, and can confirm that an estimate for the construction can be sent.

If a specialized technician wants to participate in the construction, the technician can input an estimate via the technician terminal 200. That is, the client terminal 100 transmits a request signal for an estimate, and the technician terminal 200 receives the request signal and transmit an estimate for the actual construction project. At this time, the request signal is not all transmitted to the technician terminal 200, but is transmitted to the technician terminal 200 together with the alarm signal of the alarm unit 210 only when the conditions set by the technician are satisfied.

The technician terminal 200 that receives the push alarm from the alarm unit 210 can activate a chat room creating unit 50 so that the technician terminal 200 and the client terminal 100 can directly communicate with each other and share information related to the construction. That is, the chat room creating unit 50 is activated in each of the client terminal 100 and the technician terminal 200 so that the client and technician can directly communicate with each other, and various information about the construction including estimates can be transmitted and received.

However, in order to enable smooth communication between the client terminal 100 and the technician terminal 200, the system for providing a construction mediation service according to the present invention may further include a mediation server 300 that can communicate with the client terminal 100 and the technician terminal 200. The main function of the mediation server 300 is to identify the nature of the construction and guide the matching between the client and the technician, and to proceed with a contract between the matched client and the technician.

If negotiations regarding the estimate between the client and the technician is completed, the client must pay the agreed deposit to the mediation server 300. In other words, only when the client completes the deposit to the mediation server 300, the construction start signal can be sent from the mediation server 300. As a result, the occurrence of unpaid debts due to the construction progress can be prevented in advance. In this specification, the description has been given of deposits being made to the mediation server 300, but the deposit recipient may be a guarantee institution located in the mediation server 300 or a settlement agency. In other words, the type of deposit recipient is not limited as long as it is a financial institution that can handle funds, collateral, or the like.

However, in the case of deposits, the type and ratio thereof can be adjusted by agreement between the client and the technician. For example, in relation to the type of deposit, the deposit is mostly cash, but the client can provide real collateral instead of cash, and a mixed deposit can be made by appropriately negotiating cash and collateral. As another example, a part of the deposit can be paid by points, and other benefits such as card payment and fee discounts can be given when paying the deposit. In addition, in relation to the ratio of the deposit by way of example, instead of allocating the deposit to the entire construction cost, it is also possible to deposit 70% of the construction cost as a deposit and pay the remaining 30% as a balance. However, in relation to the ratio of the deposit, it is desirable to apply it only to construction that can be separated for each process in order to prevent non-payment of construction costs. As an example, in a construction project that can be divided into three processes, if the deposit for two processes is paid first, the construction for those two processes will proceed first, and after the two processes are completed, paying the deposit for the remaining one process after the completion of the two processes would be a desirable way to prevent non-payment of construction costs.

The client can pay this deposit in a lump sum or in installments. In particular, the client can pay the deposit through a card installment payment method. This type of card installment payment method is the first to be attempted in the construction industry, and clients who are short of funds can utilize this card installment system, which provides the effect of reducing the financial burden.

For example, if a client wishes to pay a deposit of 3 million won to proceed with interior construction work, the client can pay the deposit of 3 million won in 3-month installments through a card payment method. The deposit is settled to the technician through the settlement agency and the meditation platform. In the above example, the technician can receive the remaining 95% (KRW 2.85 million) after deducting the mediation service fee (KRW 150,000) equivalent to 5% of the deposit of KRW 3 million from the settlement agency and the mediation platform.

However, the settlement method as described above is based on the premise that the technician completes the construction. If the client pays the deposit but the technician does not proceed with the construction and the contract is canceled, the entire deposit can be returned to the client. In other words, although the client paid the deposit of KRW 3 million in 3-month card installments, if the construction does not progress and the contract is cancelled, the client can receive a full refund of KRW 3 million without a separate cancellation fee.

Taking into consideration these various methods of deposits, the mediation server 300 may be provided with a construction analysis unit 310 that analyzes the type of construction and determines whether or not the deposit agreed upon between the client and the technician falls within the normal transaction range. That is, the construction analysis unit 310 determines information regarding the type and ratio of the deposit and guides the client to determine whether or not a normal transaction has been made between the client and the technician. In addition, the mediation server 300 is provided with a deposit confirmation unit 320 that confirms whether the deposit has been normally paid from the client terminal 100. When the deposit confirmation unit 320 completes the confirmation of whether or not the agreed deposit has been paid, it can transmit a construction start signal to the technician terminal 200.

When construction is completed according to this process, the client needs to determine whether the construction is progressing normally. Therefore, the meditation server 300 further comprises a dispute adjustment unit 330 that is activated when the client confirms the construction status and presses a dissatisfied button regarding the construction status. The dispute adjustment unit 330 is configured to alleviate the conflict of opinions between the client and the technician at the stage of completing the construction, and reviews the content of whether or not the construction contract has been performed between the client and the technician, and adjusts and arbitrates each party's claims based on this.

Finally, when the construction is completed, the review creating window is activated on the client terminal 100. The meditation server 300 is further provided with a cost settlement unit 340 that settles the construction cost to the technician when the client completes the review of the construction. That is, when the cost settlement unit 340 confirms the review and settles the entire construction cost including the deposit to the technician. Thereby, all of the construction are completed.

In the case of construction meditation platforms available on the market, a certain amount of fees is generally charged for each process, including the client's request for a construction estimate, the creation of a chat room for the client and technician to communicate with each other, sending the estimate by the technician, and matching of the client and the technician. However, in order to achieve the goal of making the matching platform free to use, the construction expert matching system according to the present invention can carry out the process of the client's request for a construction estimate, creating a chat room for the client and technician to communicate with each other, and sending the estimate by the technician, all being free of charge. In addition, the fee charged when matching the client and the technician is only charged as a success fee to the technician, and the amount is also reasonably set at about 5% of the total amount, which has the effect of greatly improving the economic convenience of the user.

Below, a construction technician matching method applicable to all construction projects nationwide, including interiors, will be described in detail with reference to accompanying drawings.

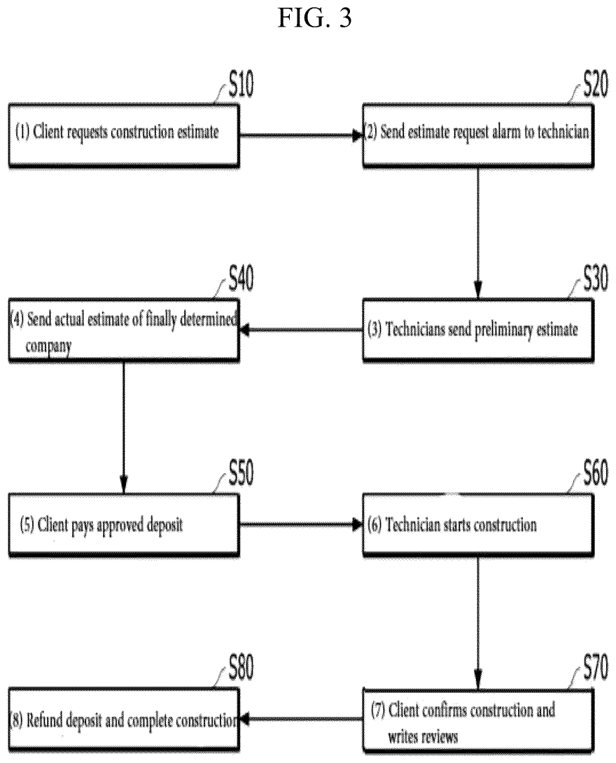

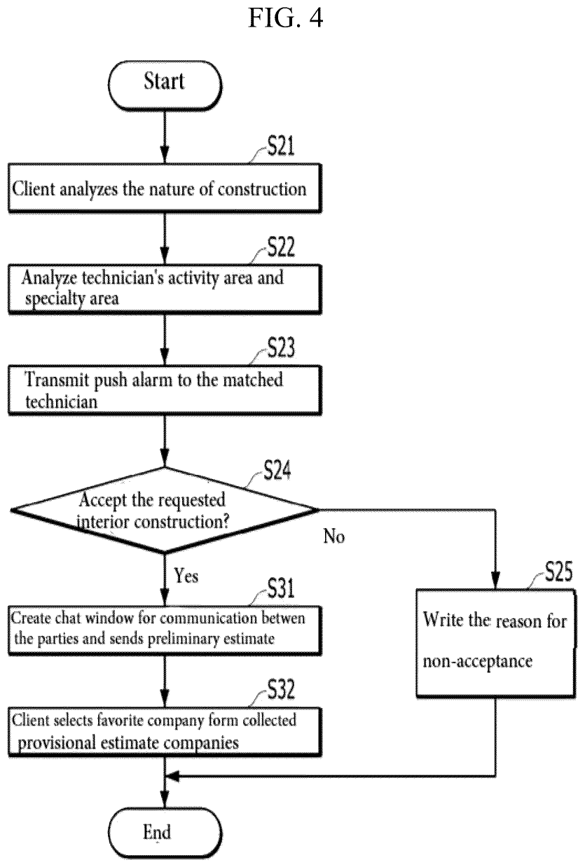

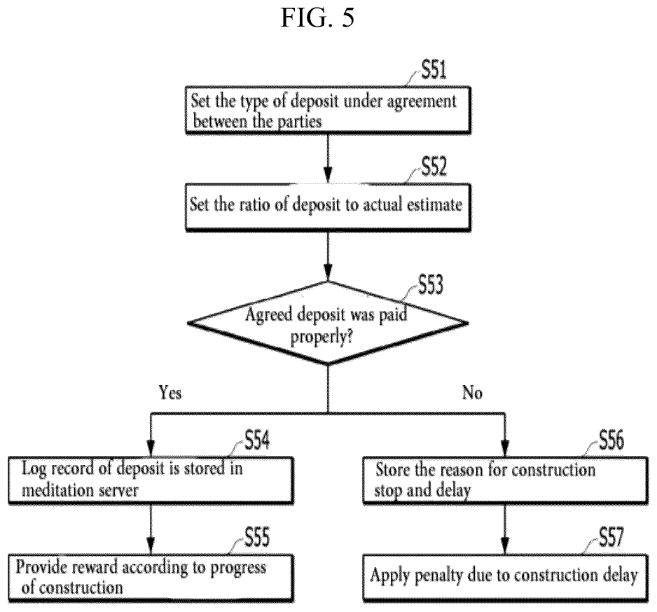

FIG. 3 is a flow chart showing the overall process of a construction contract between a client and a technician. Further, FIG. 4 is a flow chart explaining in detail the process of sending an estimate request alarm to a technician in response to a construction request from a client, and the process of sending a preliminary estimate by the technician, and FIG. 5 is a flow chart explaining the setting of a deposit and the progress of construction work depending on whether or not the deposit is paid.

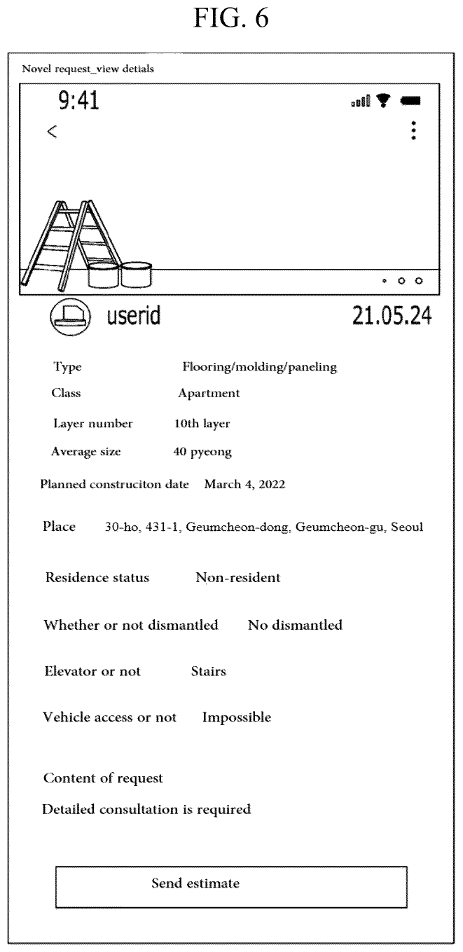

First, referring to FIG. 3, a client in need of constructions such as interior or remodeling requests a construction estimate using the client terminal 100 (S10). The area in which a client can request construction is anywhere in the country where GPS can operate, and the client can entrust construction work and request estimates. The screen for requesting a construction estimate through the client terminal 100 is shown in FIG. 6. In this way, the client can leave detailed information about the construction and request an estimate for the construction.

In accordance with such a request for a construction estimate, an estimate request alarm is transmitted to a technician terminal 200 (S20). Then, technicians who receive the transmitted alarm send an estimate to the client (S30). However, the estimate request alarm signal is not transmitted to all technician terminals 200, and the alarm signal is transmitted only to technicians within the set range. In this regard, the progress process of steps S20 and S30 will be described in more detail with reference to FIG. 4.

Referring to FIG. 4, when the client requests a construction estimate, a step of analyzing the nature of the construction is first carried out (S21). That is, the overall nature of the construction is analyzed, including the type of construction (e.g., thermal insulation, soundproofing, landscaping, demolition, etc.), the location of the construction (e.g., glass, middle door, lighting, tile, bathroom, etc.), and the scope of the construction (e.g., flooring, paneling, bathroom, kitchen, etc.).

At the same time, an analysis procedure regarding the technician's activity area and specialty area is carried out (S22). That is, a step is performed to determine whether or not the location of the construction site falls within the technician's activity area and whether or not the nature of the construction falls within the technician's specialty area. If the nature of the construction and the construction location fall within the technician's specialty area and activity area, a push alarm is transmitted to the technician terminal 200 only for the matched technician (S23).

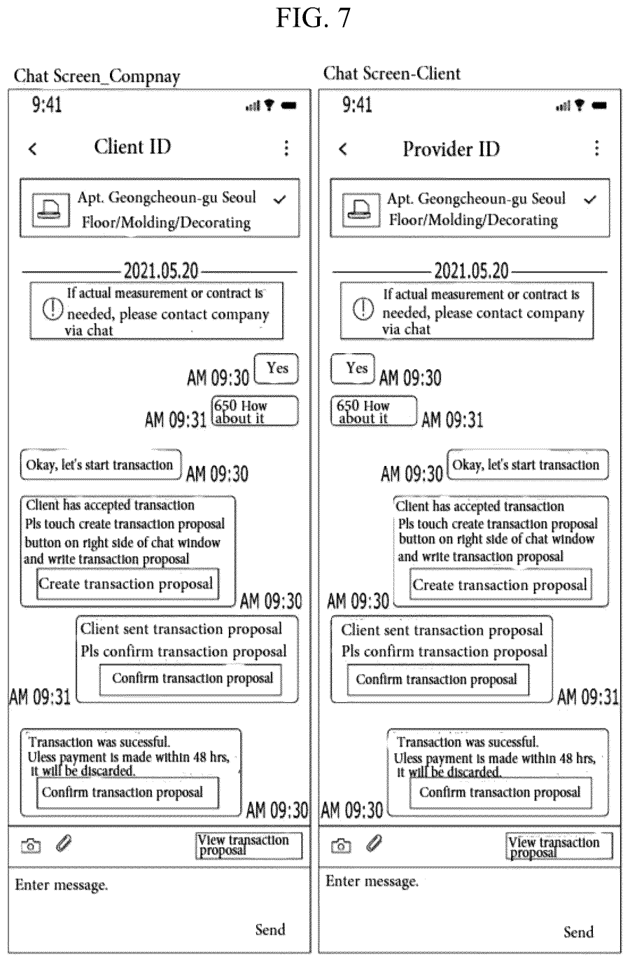

Next, the technician who received the push alarm proceeds a step of determining whether or not to accept the requested construction (S24). If the technician accepts the requested construction, a chat window is created in order to exchange information about the construction between the client and the technician, and the technician proceeds a step of sending a preliminary estimate based on the chat content (S31). Then, the client can select the most favorite company from the collected provisional estimate companies (S32). FIG. 7 shows an example of a chat screen between the client and the technician. In this way, a chat window can be activated on each of the client terminal 100 and the technician terminal 200 so as to allow free consultation regarding the construction.

On the other hand, if the technician does not want to participate in the requested construction at the step S24, the technician can press the “not participating in construction” button on the technician terminal 200 to express the intention (S25). At this time, the technician can also write the reason for not participating in the construction (optional). If the technician writes the reason that is not accepted, further recommendations or alarms regarding the construction corresponding to that reason may be blocked.

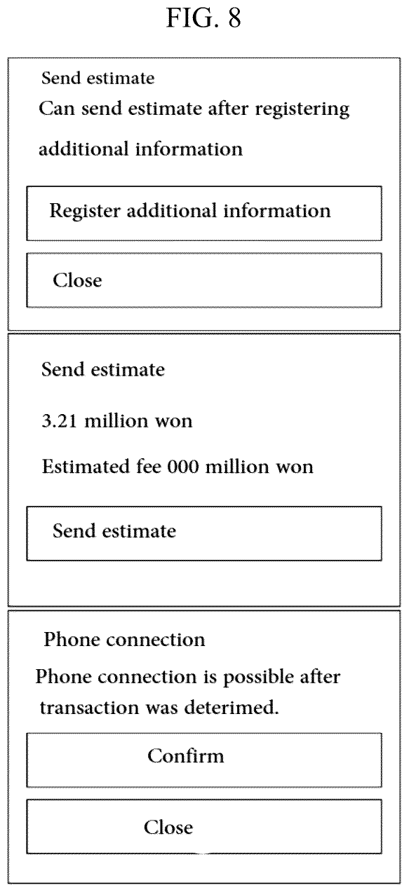

Returning to FIG. 3 again, when a match is made between the client and the technician, the process of sending the finalized company's actual estimate is carried out through a process such as the technician's visit to the construction site or face-to-face consultation (S40). For ease of understanding, FIG. 8 shows the screen for sending the finalized estimate of the technician.

Once the total cost of the construction has been determined based on the technician's actual estimate, the client proceeds to deposit funds into the meditation server 300 (S50). The details related to the deposit are shown in detail in FIG. 5. Referring to FIG. 5, the client and the technician can set the type of the deposit under agreement (S51). Generally, cash is the most commonly used form of deposit, but points managed by the mediation server 300, collateral provided by the client, or physical items can be used in place of cash. In addition, the client can pay the deposit in a lump sum or in installments. In particular, the client can also pay the deposit through a card installment payment method.

In addition, the client and the technician can also further set the ratio of the deposit to the actual estimate (S52). For example, if it is assumed that lighting construction work is to be done in the kitchen and bathroom, negotiation is possible, including paying a deposit of 80% at an initial stage to start the lighting work in the kitchen, and then once the lighting work is completed, paying the remaining 20% to start the lighting work for the remaining bathroom. However, it is desirable to set the ratio of the deposit as described above only when the content of the construction work is separable. That is, in order to prevent non-payment of the cost after the construction, it is desirable to complete the payment to the meditation server 300 before the construction, whereby when the construction work is separable, it would be in line with the purpose of the present invention to set separate each deposit for some construction.

When the negotiation regarding the type of deposit and the ratio setting is completed, the meditation server 300 determines whether the deposit agreement is appropriate and checks whether the agreed deposit has been paid in full (S53). If the deposit has been paid appropriately, log record of the deposit payment in full is stored in the meditation server 300 (S54), and a reward is provided to both the client and the technician in accordance with the normal progress of the construction (S55). An example of the reward may be the payment of points that can be used by the meditation server 300.

However, if the deposit is not paid at the step S53, the meditation server 300 sends a construction stop and a delay signal and stores the reason for this (S56). Further, if it is determined that the deposit was not paid without any particular reason, the meditation server 300 applies a penalty due to the delay and stop of construction to the client, such as a reduction in points (S57).

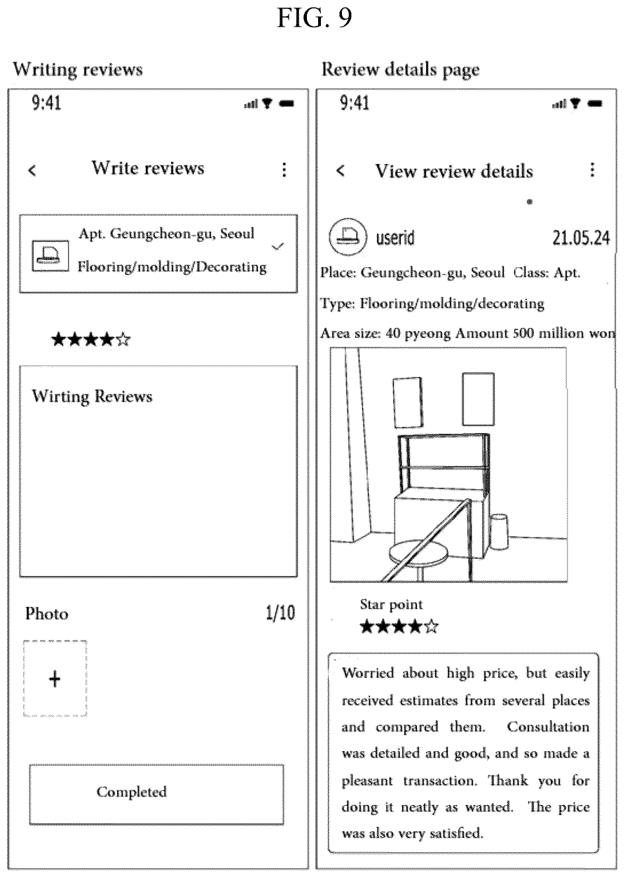

Returning to FIG. 3 again, when payment of the deposit is completed in the meditation server 300 according to this process, the technician starts to proceed with the construction normally (S60). When the construction is completed, the client checks the status of the construction, and a review writing window is activated on the client terminal 100 to display the client's level of satisfaction with the construction, or the like (S70). FIG. 9 shows a screen where the review writing window is activated and the client can write a review. Then, the client writes an overall review of the construction, and a log record of the review writing is transmitted to the meditation server 300.

When the client's review is completed in this way, the mediation server 300 performs a process of settling the deposit already paid by the client to the technician (S80). In this way, the cost settlement and communication process among the client, technician, and meditation server must be completed for the relevant construction to be completed.

Although the present invention has been described above with reference to embodiments, it will be understood by those skilled in the art that various modifications and changes can be made to the present invention without departing from the spirit and scope of the present invention as set forth in the claims below.

1. A system for providing a construction mediation service, comprising:
a client terminal for setting construction site location information and the construction type, and requesting an estimate of the construction;
a technician terminal for receiving the construction estimate request, identifying the construction type, and inputting the construction estimate;
a mediation server for communicating with the client terminal and with the technician terminal, guiding matching between a client and a technician, and mediating a contract between the matched client and technician; and
a communication network for connecting the client terminal, the technician terminal, and the mediation server in a wired or wireless manner,
wherein the mediation server comprises:
a construction analysis unit for analyzing the construction type and determining whether a deposit agreed on between the client and the technician belongs to a normal transaction range; and
a deposit confirmation unit for confirming whether the deposit has been transferred from the client terminal to the mediation server and, if the total amount of the deposit has been transferred, sending a construction start signal to the technician terminal.

2. The system for providing a construction mediation service according to claim 1, wherein the mediation server further comprises:
a dispute adjustment unit that is activated when the client confirms the state in which construction is completed and presses a dissatisfied button regarding the construction status, thereby reviewing the content of the construction contract performance between the client and the technician.

3. The system for providing a construction mediation service according to claim 1, wherein the technician terminal comprises:
an alarm unit that identifies the type of construction work transmitted from the client terminal, extracts information regarding the construction activity area of the technician, and sends a push alarm to the technician within the set information range.

4. The system for providing a construction mediation service according to claim 3, wherein the technician terminal that receives the push alarm from the alarm unit communicates with the client terminal, and the chat room generation unit is activated so as to share information about the construction, including the estimate.

5. A method for providing a construction mediation service, the method comprising:
a step of analyzing the type of construction requested by a client and the location of the construction site when a request signal for a construction estimate is sent by the client;
a step of transmitting an alarm regarding a request for a construction estimate to a technician terminal capable of performing the construction, based on the results of analyzing the type of construction and the location of the construction site;
a step of transmitting a preliminary estimate to the client by the technician who receives the alarm;
a step in which the client selects a technician based on the contents of the preliminary estimate and receives an actual estimate from the technician;
a step in which the client pays the deposit agreed upon in the actual estimate to the meditation server;
a step in which the technician progresses the construction when payment of the deposit is confirmed by the meditation server;
a step in which the client confirms the status of the construction and writes a review after the construction is completed; and
a step in which the meditation server completes the cost settlement including the deposit and finish the construction when the client's review is completed.

6. The method for providing a construction mediation service according to claim 5, wherein the step of paying a deposit to the meditation server comprises:
a step of setting the type of deposit under agreement between the client and the technician, and setting the ratio of the deposit to the amount of the actual estimate;
a step of determining whether or not the deposit agreed upon between the client and the technician has been paid in the mediation server; and
a step of storing log record of the deposit payment in full in the mediation server when the deposit payment has been completed, and providing a reward according to normal construction progress.

7. The method for providing a construction mediation service according to claim 6, wherein in the step of determining whether or not the deposit agreed upon between the client and the technician has been paid, if information about an unpaid deposit is received from the meditation server, the meditation server progresses a step of sending a signal to the technician to stop construction and storing the reason for the delay in construction; and a step of applying a penalty caused by the delay in construction to the client.

8. The method for providing a construction mediation service according to claim 5, wherein the step of transmitting an alarm regarding a request for a construction estimate to a technician terminal comprises:
a step of analyzing the nature of the construction for which the client has requested an estimate, the location of the construction site, the technician's area of activity, and the technician's specialized construction field, and sending an alarm to the matched technician;
a step in which a technician selects whether or not to accept the requested construction; and
a step of creating a chat window for the client and the technician to communicate about the construction, including the estimate, when the technician accepts the construction.
